(19) United States
(12) Patent Application Publication
(10) Pub. No.: US 2022/0154725 A1
(43) Pub. Date: May 19, 2022

(54) FAN ASSEMBLY HAVING A VARIABLY ADJUSTABLE PLUG-CONNECTOR OUTLET

(71) Applicant: ebm-papst St. Georgen GmbH & Co. KG, St. Georgen (DE)

(72) Inventors: Hassan GHODSI-KHAMENEH, Offenburg (DE); Johannes HIRT, St. Georgen/Brigach (DE); Frank RATH, Rottweil (DE); Claas DRESCHER, Tuttlingen (DE)

(21) Appl. No.: 17/599,954

(22) PCT Filed: Apr. 16, 2020
(86) PCT No.: PCT/EP2020/060745

§ 371 Date: Sep. 29, 2021

(30) Foreign Application Priority Data
May 27, 2019 (DE) 10 2019 114 068.4

(51) Int. Cl. F04D 25/06; F04D 29/62; F04D 29/42

(52) U.S. Cl. CPC F04D 25/0606; F04D 29/4226; F04D 29/624

(57) ABSTRACT

The disclosure relates to a fan assembly comprising a fan housing, which has a housing lid rotatably mounted on the fan housing, and a stator assembly, comprising windings, of an electric motor mounted on the housing lid, the windings of which can be electrically connected by means of a plug connector, wherein a plug connector is provided for this purpose on the housing lid, the position of which plug connector can be changed and/or adjusted with respect to the fan housing by rotating the housing lid about a rotational angle α.

### RELATED APPLICATIONS

This application claims priority to and is a 35 U.S.C. § 371 national phase application of PCT/EP2020/060745, filed Apr. 16, 2020 and claims priority to German Patent Application No. 10 2019 114 068.4, filed May 27, 2019, the entire contents of which are incorporated herein by reference in their entirety.

### FIELD

The disclosure relates to a fan assembly and to a fan having a variably adjustable plug-connector outlet.

### BACKGROUND

In various applications, it is necessary to implement the electrical connection of a fan as a function of its installation situation. Since conventional fans and ventilators usually provide a fixed position for the connection, a large number of variants are required in order to accommodate the various installation scenarios.

If, for example, a connection position of 90° opposite the exhaust opening of the fan is required in a left-hand drive vehicle, whereas a position of 270°, for example, may be required for the same vehicle with right-hand drive.

In principle, we have found it would also be helpful if a large number of installation conditions with regard to the electrical connection could be easily implemented with one type of fan. If a user wishes to arrange a plug outlet in different directions depending on the end product, this should be done without having to keep a large number of variants on hand and without additional tool costs.

### BRIEF SUMMARY

The disclosure is therefore based on the object of overcoming the aforementioned drawbacks which are present in the prior art and of making available a simple and inexpensive variable connection option for a fan.

This object is achieved by the combination of features according to claim 1.

According to the disclosure, a fan assembly is proposed for this purpose which comprises a fan housing with a housing lid that is rotatably mounted on the fan housing, and a stator assembly, comprising windings, of an electric motor that is mounted on the housing lid, the windings of which stator assembly can be electrically connected by means of a plug connector, a plug connector being provided for this purpose on the housing lid, the position of which plug connector can be changed and/or adjusted with respect to the fan housing by rotating the housing lid about a rotational angle α.

A desired orientation or mounting position of the plug connector can thus be achieved in the angular range between 0° and 360° with respect to the central axis of rotation of the housing lid.

A configuration in which the plug connector is integrally formed, particularly materially bonded, with the housing lid is especially advantageous. The housing lid thus forms not only a receptacle for the stator assembly, but also a housing for the contact carrier and the contacts of the plug connector.

In another advantageous embodiment of the disclosure, a provision is made that the housing lid is preferably pot-shaped with a lid plate and a circumferential cylindrical wall (pot wall) with an inner diameter Di.

It is also advantageous if the fan housing has a cylindrical wall with an outer diameter Da that is attached around an opening and extends outward from the fan housing.

Through appropriate coordination of inner diameter and outer diameter, a sealed pivot bearing can be realized.

It is particularly advantageous if the cylindrical wall of the housing lid overlaps and/or encloses the cylindrical wall of the fan housing at least partially.

The inner wall of the cylindrical wall of the lid can have a step for the purpose of realizing a pivot bearing. In the assembled state, the end face of the wall of the housing is advantageously in contact with the step in the lid, which step forms a support for the cylindrical wall.

In order to realize an optional seal, in particular a plain bearing seal, a circumferential seal can be arranged between the cylindrical wall of the housing lid and the cylindrical wall of the fan housing, in which case the coordination of the previously described inner diameter and outer diameter of the two cylindrical walls is then selected to as to be appropriate depending on the seal design.

In another advantageous embodiment of the disclosure, a provision is made that a circuit board is arranged in or on the housing lid on which the stator assembly (and possibly motor electronics) is provided, and electrical connection lines lead from the circuit board or the electrical components to the plug connector. By virtue of the concept of the rotatable arrangement of the entire stator assembly relative to the housing about the rotor, a variable plug position is thus realized in a simple manner.

In a likewise advantageous embodiment of the disclosure, a provision is made that the fan housing is a spiral housing with a radial discharge opening. In this case, the opening for introducing the stator assembly is provided with the housing-side cylindrical wall on a side surface of the spiral housing through which both the axis of rotation of the housing lid and the axis of rotation of the rotor run, these spanning a common axis of rotation.

It is also advantageous if the plug connector extends with its plug-in direction radially outward with respect to the center of the housing lid, with the center of the lid also defining the axis of rotation.

Another aspect of the present disclosure relates to a fan, particularly to a radial fan, having a fan assembly as described above.

Another aspect of the present disclosure relates to a method for adjusting the position of a plug connector of a fan assembly as described above or of a fan, comprising the following steps:

a. Rotating the rotatably mounted housing lid by a desired rotation angle α in order to set a specific rotational position of the housing lid with respect to the fan housing, and

b. securing the housing lid in the set position, preferably by means of a form fit and/or material bond, particularly through gluing, welding, riveting, screwing.

It is also advantageous if a fastening means for securing the housing lid in the set position is simultaneously provided radially circumferentially between the housing lid and the fan housing as a sealing means for sealing the fan housing, preferably in the form of an applied sealing bead.

For this purpose, it is conceivable to first introduce a sealing bead into a circumferential groove and then to position the rotatable lid on the housing and bring it into the desired rotational position. If the sealant of the sealing bead is then chemically crosslinked, a mechanical connection as well as a housing seal is achieved in this area.

### BRIEF DESCRIPTION OF THE DRAWINGS

Other advantageous refinements of the disclosure are characterized in the subclaims and/or depicted in greater detail below together with the description of the preferred embodiment of the disclosure with reference to the figures.

In the drawings:

FIG. 1 shows a perspective view of an exemplary embodiment according to the concept of the present disclosure in a first plug position and in a second plug position that deviates therefrom;

FIG. 2 shows a superposed perspective view of an exemplary embodiment according to the concept of the present disclosure in a first plug position and in a second plug position that deviates therefrom;

FIG. 3 shows a plan view of an exemplary embodiment according to the concept of the present disclosure in a first plug position and in a second plug position that deviates therefrom;

FIG. 4 shows a perspective view of the stator assembly from FIGS. 1 to 3;

FIG. 5 shows a perspective view from below of the stator assembly according to FIG. 4;

FIG. 6 shows a top view of the stator assembly according to FIG. 5; and

FIG. 7 shows a sectional view through the stator assembly according to FIG. 6 along the sectional line A-A.

### DETAILED DESCRIPTION

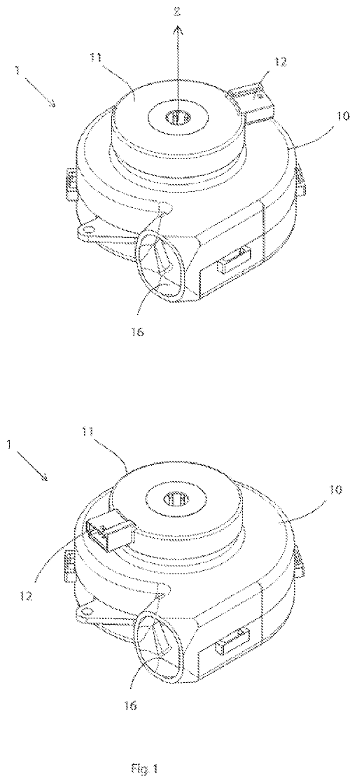

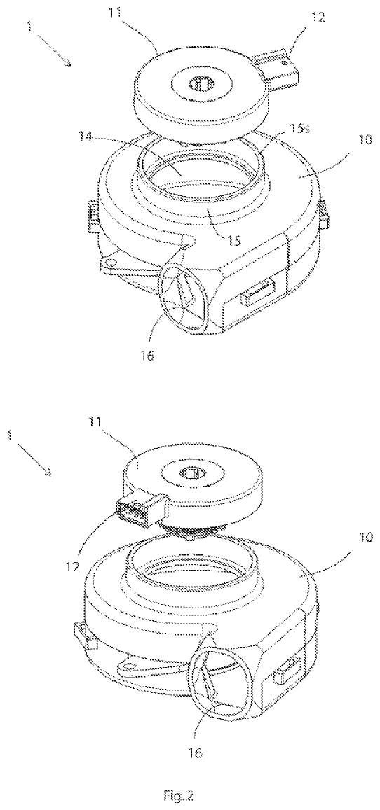

The disclosure will be explained in greater detail below with reference to FIGS. 1 to 7 on the basis of an exemplary embodiment, with same reference symbols in the figures indicating same structural and/or functional features.

FIGS. 1 to 3 each show views of an exemplary embodiment according to the concept of the present disclosure with the plug connector 12 in a first plug position and in a second plug position that deviates therefrom. These figures each show a fan assembly 1 with a fan housing 10, specifically a spiral housing with a radial discharge opening 16.

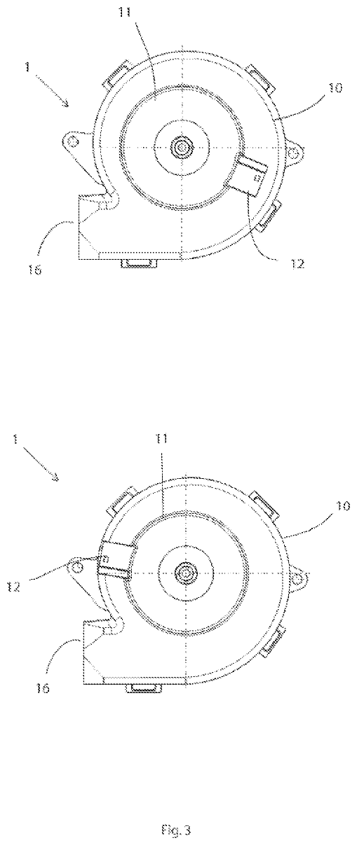

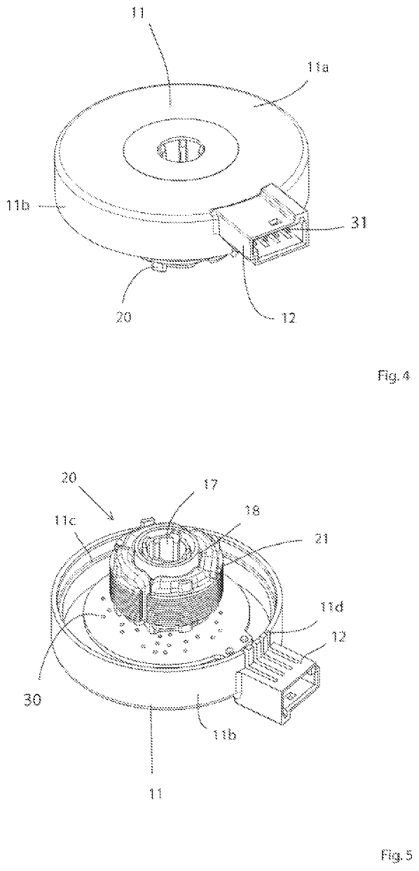

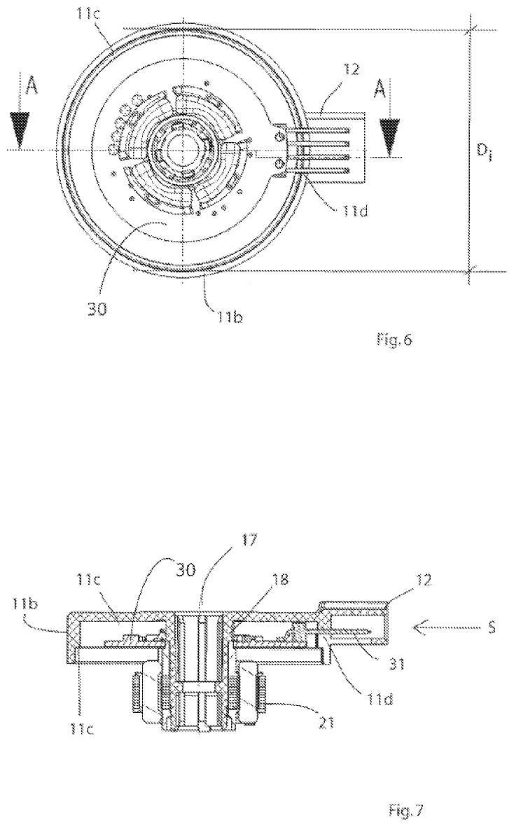

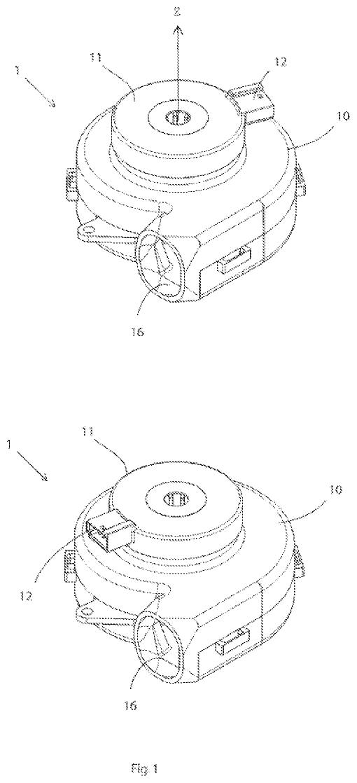

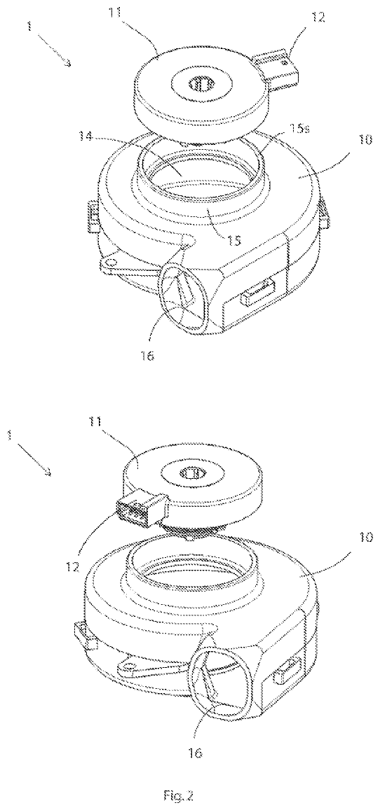

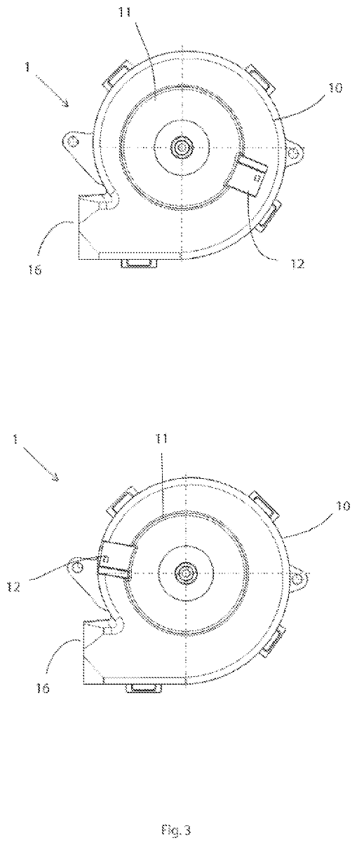

A rotatably mounted housing lid 11 is mounted in different angular positions on the fan housing 10 in the illustrations of FIGS. 1 and 3.

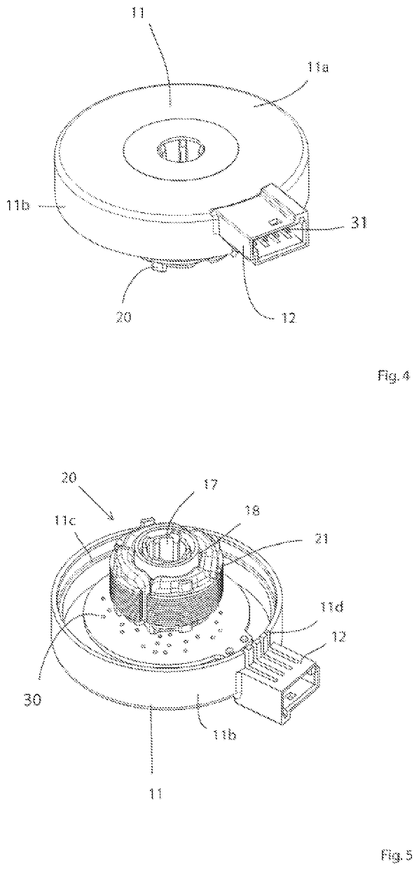

Furthermore, a stator assembly 20 of an electric motor is shown which is illustrated in FIG. 2 in a non-assembled, superposed position relative to the housing. The stator assembly 20 has windings 21, as can be seen particularly in FIG. 5.

A printed circuit board 30 is arranged on the housing lid 11 on which the stator assembly 20 is connected and, from there, electrical connection lines 31 lead to the plug connector 12.

The plug connector 12, the position of which relative to the fan housing 10 can be changed and/or adjusted by rotating the housing lid 11 by a rotation angle, is provided integrally on the housing lid 11.

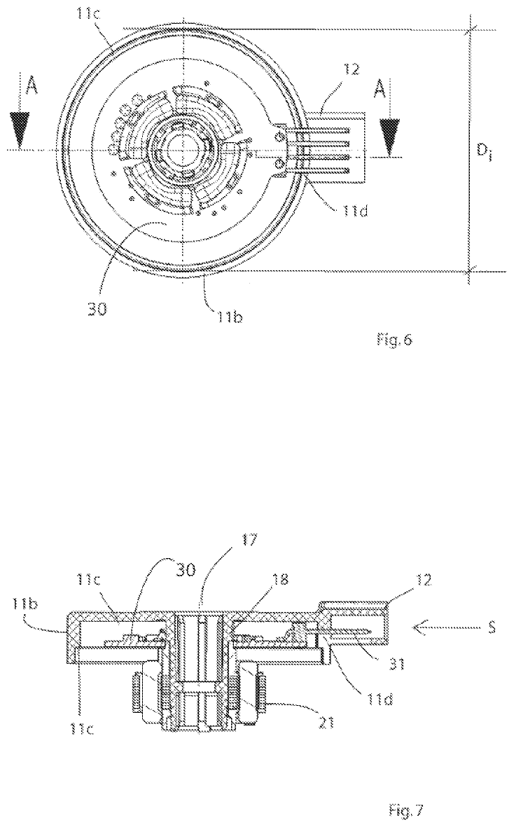

The housing lid 11 is pot-shaped with a lid plate 11a and a circumferential cylindrical wall 11b with an inner diameter Di and has a central opening 17 for a rotor. The plug connector 12 is embodied as a radially lateral outlet with a plug-in direction S. The printed circuit board 30 is attached to the inside of the lid plate 11a and has a central opening, as can be seen clearly in FIG. 7, through which a cylindrical flange 18 runs on which the stator assembly 20 is mounted. The contacts 31 are mounted on the circuit board and run with their contact pin through the cylindrical wall 11b into the plug-receiving space of the plug connector 12, particularly through recesses 11d in the wall 11b that are open toward the edge of the wall.

The fan housing 10 has an opening 14 on the side surface or top surface. The opening 14 is surrounded by a cylindrical wall 15 that extends outward from the fan housing 10, the outer diameter being smaller than the inner diameter of the cylindrical wall 11b of the housing lid 11. When the housing lid 11 is in the assembled state, the cylindrical wall 11b of the housing lid 11 overlaps the cylindrical wall 15 of the fan housing 10, creating a rotatable mount. As can be seen in FIGS. 5 and 7, this can be achieved in an especially advantageous manner through provision of the inner wall of the cylindrical wall 11b with a step 11c. The wall 11b thus has a first ring section, which has a first inner diameter, and a second ring section (separated by the step), which has a second, somewhat larger inner diameter but is only slightly larger than the outer diameter of the cylindrical wall 15 of the fan housing 10. In the assembled state, the end face 15s of the cylindrical wall 15 then rests against the step 11c, which forms a support for the cylindrical wall 15.

The disclosure is not limited in its execution to the abovementioned preferred exemplary embodiments. Rather, a number of variants are conceivable that make use of the illustrated solution even in the form of fundamentally different embodiments.

1. A fan assembly, comprising
a. a fan housing with a housing lid that is rotatably mounted on the fan housing;
b. a stator assembly, comprising windings, of an electric motor mounted on the housing lid, the windings configured to be electrically connected way of a plug connector provided on the housing lid, wherein the position of the plug connector can be changed and/or adjusted with respect to the fan housing by rotating the housing lid about a rotational angle α.

2. The fan assembly as set forth in claim 1, wherein the plug connector is integrally formed, particularly materially bonded, with the housing lid.

3. The fan assembly as set forth in claim 1, wherein the housing lid is pot-shaped with a lid plate and a circumferential cylindrical wall with an inner diameter Di.

4. The fan assembly as set forth in claim 1, wherein the fan housing has a cylindrical wall with an outer diameter that is attached around an opening and extends outward from the fan housing.

5. The fan assembly as set forth in claim 4, wherein the cylindrical wall of the housing lid overlaps and/or encloses the cylindrical wall of the fan housing at least partially.

6. The fan assembly as set forth in claim 5, wherein the inner wall of the cylindrical wall has a step and, when the housing lid is in the assembled state, an end face of the cylindrical wall is in contact with the step, which forms a support for the cylindrical wall.

7. The fan assembly as set forth in claim 1, wherein a printed circuit board is arranged in or on the housing lid on which the stator assembly is connected and electrical connection lines lead to the plug connector.

8. The fan assembly as set forth in claim 1, wherein the fan housing is a spiral housing with a radial discharge opening.

9. The fan assembly as set forth in claim 1, wherein the plug connector extends with its plug-in direction (S) radially outward with respect to a center (Z) of the housing lid.

10. A radial fan, comprising a fan assembly as set forth in claim 1.

11. A method for adjusting the position of a plug connector of a fan assembly as set forth in claim 1, comprising the following steps:
a. rotating the housing lid about a central axis of rotation by a specific rotation angle in order to set a specific rotational position of the housing lid with respect to the fan housing, and
b. securing the housing lid in the set position, by way of a form fit and/or material bond.

12. The method of claim 11, wherein a fastening means for securing the housing lid in the set position is simultaneously provided radially circumferentially between the housing lid and the fan housing as a seal for sealing the fan housing.

13. The method of claim 11, wherein the step of securing the housing lid in the set position is by way of gluing, welding, riveting, or screwing.

14. The method of claim 12, wherein the seal takes the form of an applied sealing bead.
